(19) United States
(12) Patent Application Publication
(10) Pub. No.: US 2017/0199762 A1
(43) Pub. Date: Jul. 13, 2017

(54) ENHANCED PRIORITIZATION OF TASKS IN REAL-TIME

(71) Applicant: International Business Machines Corporation, Armonk, NY (US)

(72) Inventors: John P. Bufe, III, Washington, DC (US); Narine Cholakyan, Austin, TX (US); Taffie B. Coler, Austin, TX (US); Ramakrishnan Rajamony, Austin, TX (US)

(21) Appl. No.: 14/993,921

(22) Filed: Jan. 12, 2016

(51) Int. Cl. G06F 9/48; G06N 99/00; G06F 13/18

(52) U.S. Cl. CPC G06F 9/4881; G06F 13/18; G06N 99/005

(57) ABSTRACT

Techniques are described for a real-time prioritization of service tasks. In one example, a method includes receiving one or more customer activity inputs associated with one or more service tasks for performing in a service establishment on behalf of customers of the service establishment. The method further includes receiving one or more metadata items associated with the one or more service tasks. The method also includes determining a prioritization of the one or more service tasks based on the one or more customer activity inputs, wherein determining the prioritization includes generating a prioritization value for the one or more service tasks based at least in part on at least one of the one or more metadata items or the one or more customer activity inputs, and updating the one or more service tasks based on the prioritization value.

### TECHNICAL FIELD

This disclosure relates to front-end retail software systems.

### BACKGROUND

There are several tasks that occur during the progress of a food service. In the food industry, a waiter typically is given a number of different customers with different tasks for each, such as seating new customers, taking food and drink orders, retrieving food and drink orders, and preparing the check.

### SUMMARY

In one aspect of the invention, a method includes receiving one or more customer activity inputs associated with one or more service tasks for performing in a service establishment on behalf of customers of the service establishment. In another example, the method also includes receiving one or more metadata items associated with the one or more service tasks. The method further includes determining a prioritization of the one or more service tasks based on the one or more customer activity inputs, wherein determining the prioritization comprises generating a prioritization value for the one or more service tasks based at least in part on at least one of the metadata items or the one or more customer activity inputs, and updating the one or more service tasks based on the prioritization value.

In another aspect, a computer system includes one or more processors and one or more computer-readable memories. The computer system also includes program instructions, stored on at least one of the one or more storage devices for execution by at least one of the one or more processors via at least one of the one or more memories, to receive one or more customer activity inputs associated with one or more service tasks for performing in a service establishment on behalf of customers of the service establishment. In another example, the computer system also includes program instructions to receive one or more metadata items associated with one or more service tasks. The computer system further includes program instructions to determine a prioritization of the one or more service tasks based on the one or more customer activity inputs, wherein program instructions to determine the prioritization comprises program instructions to generate a prioritization value for the one or more service tasks based at least in part on at least one of the one or more metadata items or the one or more customer activity inputs, and program instructions to update the one or more service tasks based on the prioritization value.

In another aspect, a computer program product includes a computer-readable storage medium having program code embodied therewith, the program code executable by a processor to identify a pattern of stop events in a program. The computer program product further includes program code to receive one or more customer activity inputs associated with one or more service tasks for performing in a service establishment on behalf of customers of the service establishment. The computer program product further includes program code to receive one or more metadata items associated with the one or more service tasks. The computer program product also includes program code to determine a prioritization of the one or more service tasks based on the one or more customer activity inputs, wherein the program code to determine a prioritization further includes program code to generate a prioritization value for the one or more service tasks based at least in part on at least one of the one or more metadata items or the one or more customer activity inputs, and program code to update the one or more service tasks based on the prioritization value.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 depicts a block diagram of a prioritization system that may perform, with one or more processors, a real-time prioritization of service tasks, in one aspect of this disclosure.

FIG. 2 depicts a block diagram of a task list, in one aspect of this disclosure.

FIG. 3 depicts a block diagram of a task module, in one aspect of this disclosure.

FIG. 4 depicts a block diagram of a prioritization metadata, in one aspect of this disclosure.

FIG. 5 depicts a flowchart of an example prioritization method, in one aspect of this disclosure.

FIG. 6 depicts a flowchart of another example prioritization method, in one aspect of this disclosure.

FIG. 7 depicts a block diagram of a computer program product that may be used to implement a debugger, in one aspect of this disclosure.

### DETAILED DESCRIPTION

Service establishments, such as restaurants or other physical retail stores, may require attention with various service tasks performed on behalf of customers of the service establishments. For example, in a restaurant, a server may manually gauge and prioritize different actions for all of the people he or she is serving. Tasks may include seating customers, providing menus, drink orders, food orders, checking on food, dessert, preparing checks, and handling payment. These tasks may require real-time prioritization to efficiently provide good service and to avoid wasting time and resources. Other retail stores, such as stores that sell both devices and services (e.g., wireless phones, computers), may involve tasks to serve customers in the store who may need to purchase new products and/or new services, and/or to seek help or technical support with existing products and/or services. A retail employee may manually gauge and prioritize different actions such as product sales, subscription sales, and technical support, to determine a priority of tasks.

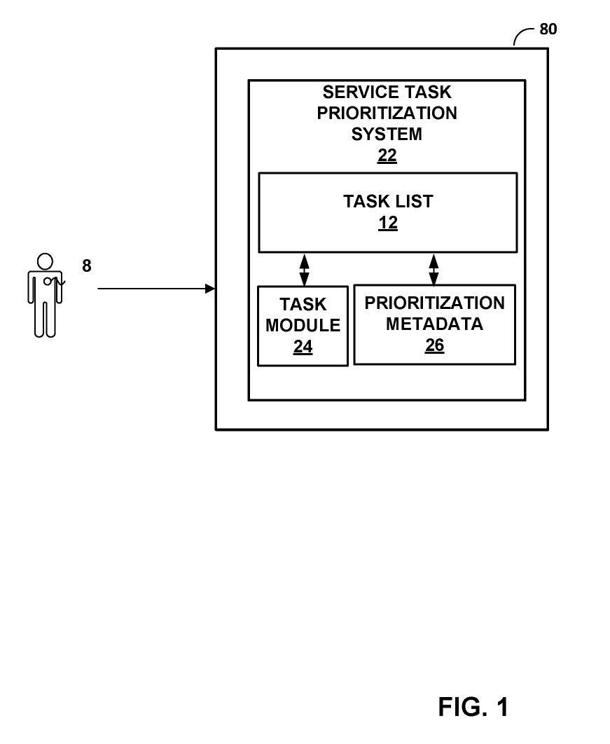

FIG. 1 depicts a block diagram of service task prioritization system 22 that may perform, with one or more processors, real-time prioritization of service tasks, in one aspect of the disclosure. FIG. 1 illustrates an example context in which service task prioritization system 22 may include task list 12, task module 24, and prioritization metadata 26 for prioritization of tasks within task list 12 for service employee 8. In one example, service employee 8 may be assigned to conduct tasks within task list 12. As service progresses, task module 24 may provide customer activity inputs, such as status updates on food and drink and/or status updates on customers entering or leaving. Service task prioritization system 22 may use customer activity inputs from task module 24 and additional information from prioritization metadata 26 to determine a prioritization of tasks from task list 12, such as generating one or more prioritization values 28 for a task. Service task prioritization system 22 may update existing service tasks in task list 12 or add new service tasks to task list 12 based on the prioritization value 28.

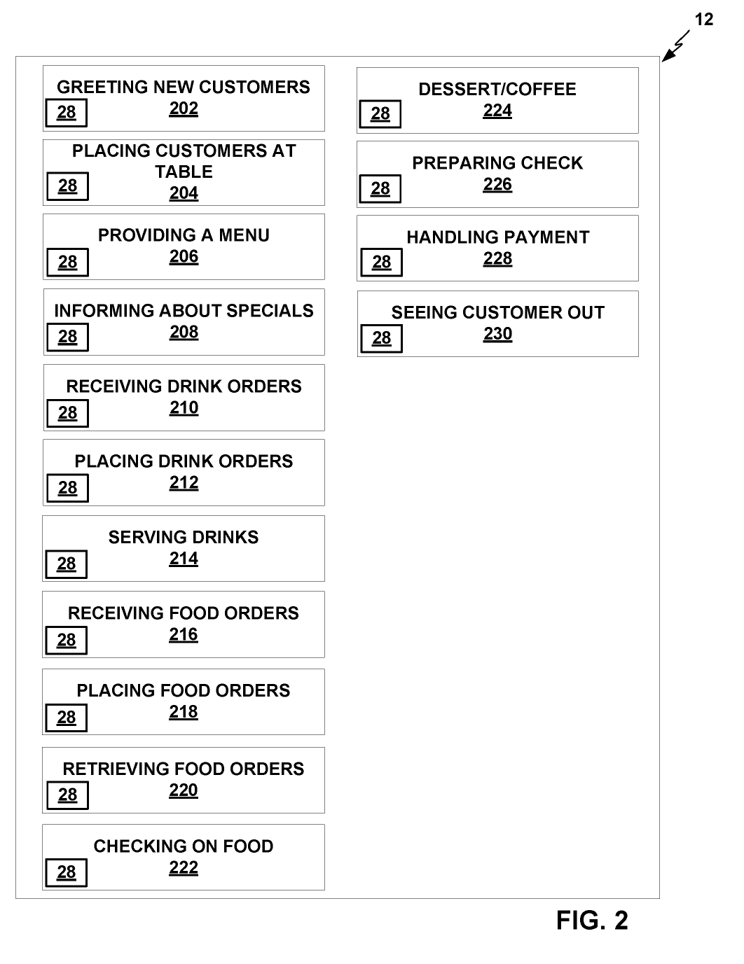

FIG. 2 depicts a block diagram of task list 12, in one aspect of this disclosure. Task list 12 may include tasks for greeting new customers 202, placing customers at table 204, providing a menu 206, informing about specials 208, receiving drink orders 210, placing drink orders 212, serving drinks 214, receiving food orders 216, placing food orders 218, retrieving food orders 220, checking on food 222, dessert/coffee 224, preparing check 226, handling payment 228, seeing customer out 230. Task list 12 may also include prioritization values 28 associated with tasks. The items in task list 12 may be interchangeable or continuous processes that occur throughout the course of a meal, and may further include other tasks during service. Service task prioritization system 22 may determine priority of tasks within task list 12 based on customer activity input from task module 24 with real-time updates on the status of drinks, food, or customers. In one example, retrieving food orders 220 may require priority over the other tasks when the kitchen finishes preparing the food. Service task prioritization system 22 may use customer activity input (e.g., status of food is ready) from task module 24 and prioritization metadata 26 associated with each task (e.g., higher urgency weighting to retrieve recently prepared food) to generate a prioritization of tasks. In response to determining the prioritization of a specific task, service task prioritization system 22 may update task list 12 and reorder tasks in accordance to prioritization value 28.

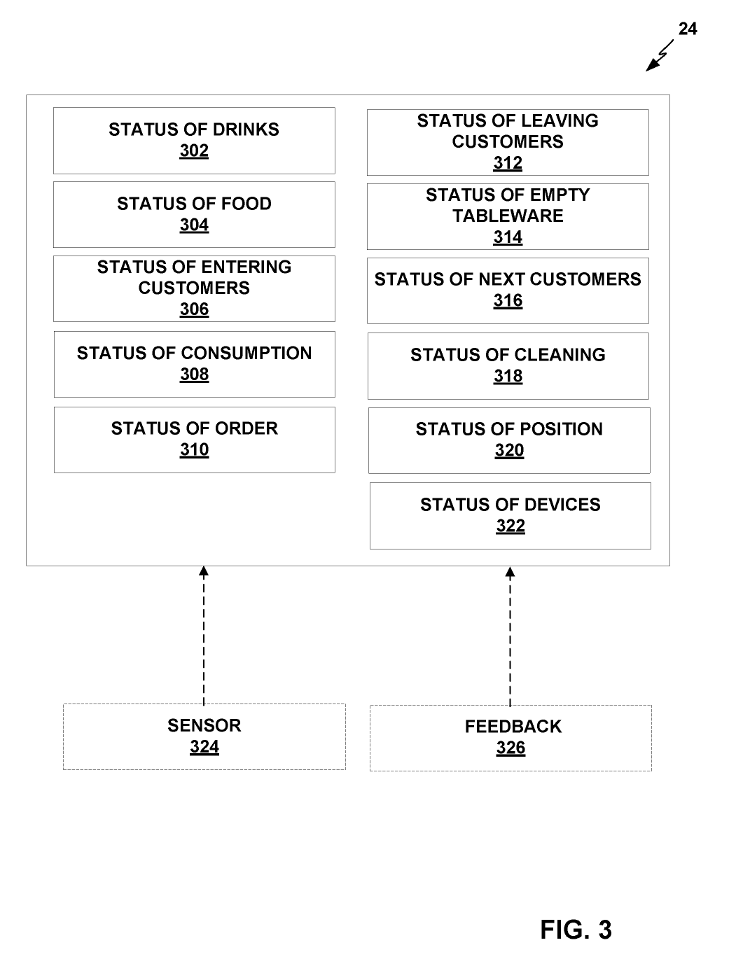

FIG. 3 depicts a block diagram of task module 24, in one aspect of this disclosure. Task module 24 may provide service task prioritization system 22 with customer activity inputs associated with various activities occurring during service such as status of drinks 302, status of food 304, status of entering customers 306, status of consumption 308, status of order 310, status of exiting customers 312, status of empty tableware 314, status of next customers 316, status of cleaning 318, status of position 320 (e.g., seat at bar or at table; technology support division or sales division, etc.), and status of devices 322 (e.g., buzzers or notification devices). For example, task module 24 may receive as input that drinks are made. Task module 24 may provide input to service task prioritization system 22 that the status of drinks is now ready and serving drinks 214 task in task list 12 is updated with a higher prioritization value 28. In another example, task module 24 may receive as input that food is prepared. Task module 24 may provide input to service task prioritization system 22 that the status of food is now ready and retrieving food orders 220 task in task list 12 is updated with a higher prioritization value 28.

In other examples, task module 24 may receive as input a status of customers, such as when new customers arrive, status of customer's consumption of food and drink, whether customers are making decisions on what to order (e.g., whether menu has not moved or the customer has decided), when customers have paid and are leaving, when customers have finished their drinks or food, when new customers are assigned an available table. In another example, task module 24 may receive as input a table status of whether a table is cleaned or requires cleaning. The status of the aforementioned customer activity inputs may provide service task prioritization system 22 information to determine a prioritization of tasks through the generation of prioritization values 28 and whether to add to or update task list 12 with a new or updated priority of tasks based on the prioritization values 28. In another example, one or more sensors 324 may provide information associated with customer activity inputs to task module 24. For example, sensor 324 may include one or more devices located throughout the service establishment that monitor the meal progress of customers. In one instance, sensors 324 may measure the amount of food and/or drink on plates, dishes, or other forms of tableware. Sensors 324 may automatically provide task module 24 with information relating to the status of food and/or drink, such as a quantifiable unit of measure including weight, force, temperature, proximity or other similar units of measure. Sensors 324 may also provide information relating to the status of food and/or drink as a binary unit that may indicate the need, or lack of need, to perform a task within the task list 12.

In another example, task module 24 may receive feedback information 326 from customers or employees for determining the priority of tasks. For example, a customer may indicate in his feedback information 326 that he preferred being seated with a clean table. Service task prioritization system 22 may use machine learning or genetic algorithms to learn from the feedback information 326 to prioritize cleaning a table above seating the new customer. In another example, service task prioritization system 22 may use feedback information 326 to modify metadata items described in this disclosure. These machine learning or genetic algorithms may be tied to a cloud-based analytics system, which may offer pattern recognition and artificial intelligence capability for modifying the prioritizations based on data and feedback information 326 through data-driven predictions and/or statistics.

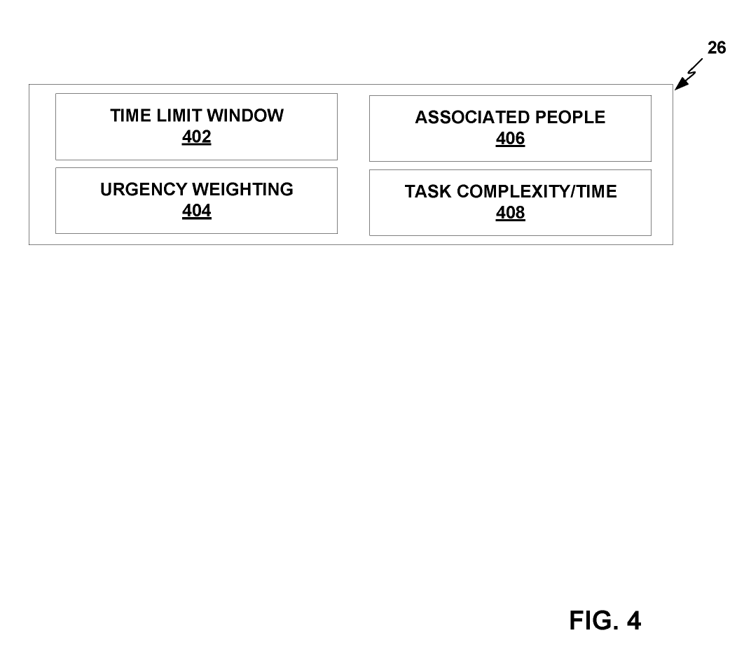

FIG. 4 depicts a block diagram of prioritization metadata 26, in one aspect of the disclosure. Prioritization metadata 26 may include items of information such as time limit window 402, urgency weighting 404, associated people 406, and task complexity/time 408 related to one or more tasks. Service task prioritization system 22 may use prioritization metadata 26 for determining a prioritization of tasks and to update or add new tasks based on a prioritization value 28.

Time limit window 402 may have information associated with one or more measurements associated with user dissatisfaction over time of tasks not completed. In other words, time limit window 402 may include time limit information based on an analysis of user dissatisfaction and the length of time of an incomplete task. The time limit information may a flexible or hard time limit. Time limit window 402 may provide service task prioritization system 22 information relating to a time limit to perform a specific task from task list 12 and service task prioritization system 22 may use this information to generate a prioritization value 28 of a particular task. For example, customers may quickly become dissatisfied when food is not retrieved in thirty minutes. In that same time, customers are less dissatisfied waiting for a table. Time limit window 402 may indicate that the time limit to retrieve food is greater than the time limit to seat new customers.

Service task prioritization system 22 may use time limit window 402 information from prioritization metadata 26 to generate a prioritization value 28 for a task within task list 12. In another example, service task prioritization system 22 may also use machine learning or genetic algorithms on feedback information 326 or customer activity inputs from task module 24, which may generate measurements of user dissatisfaction over time of tasks not completed. These measurements may be translated into confidence measurements that may contribute to overall prioritization or alter values in prioritization metadata 26.

Urgency weighting 404 may include information associated with contextual inputs such as status of restaurant and inherent importance of task to determine a weight of urgency for tasks. Status of restaurant may include information associated with the busyness of the restaurant. When a restaurant is busy, the urgency to prepare the check and see the customer out is of higher priority. An example of an inherently important task may include delivery of hot food from the kitchen rather than refilling a beverage. Prioritization metadata 26 may indicate that retrieving the food is a higher urgency weight than refilling a beverage. Service task prioritization system 22 may then use the urgency weight information to generate a prioritization value 28. In another example, prioritization metadata 26 may include an urgency weight to cleaning the tables when new customers have entered. In another example, prioritization metadata 26 may include an urgency weight to presenting a check to the customer when clearing the table is desired and/or the status of the restaurant is busy. Service task prioritization system 22 may use urgency weighting 404 information from prioritization metadata 26 to generate a prioritization value 28 for a task within task list 12. In another example, service task prioritization system 22 may also use machine learning or genetic algorithms on feedback information 326 or customer activity inputs from task module 24, which may generate a weight of urgency for a task. These weights may contribute to overall prioritization or alter values in prioritization metadata 26.

Associated people 406 may include information relating to identification of persons allowed to perform a specific task. For example, a waiter who took a food order may require his presence when the food is delivered. Other tasks, such as refilling drinks, may be performed by any available waiter. Service task prioritization system 22 may use associated people 406 information from prioritization metadata 26 to generate a prioritization value 28 for a task within task list 12.

Task complexity/time 408 may provide information associated with the level of difficulty of a task and the time it takes to complete a task. For example, informing customers about the specials is a more complicated and more time consuming task than refilling drinks. Service task prioritization system 22 may use task complexity/time 408 information from prioritization metadata 26 to generate a prioritization value 28 for a task within task list 12. In another example, service task prioritization system 22 may also use machine learning or genetic algorithms on feedback information 326 or customer activity inputs from task module 24, which may generate a task complexity/time value for a task. These complexity/time values may contribute to overall prioritization or alter values in prioritization metadata 26.

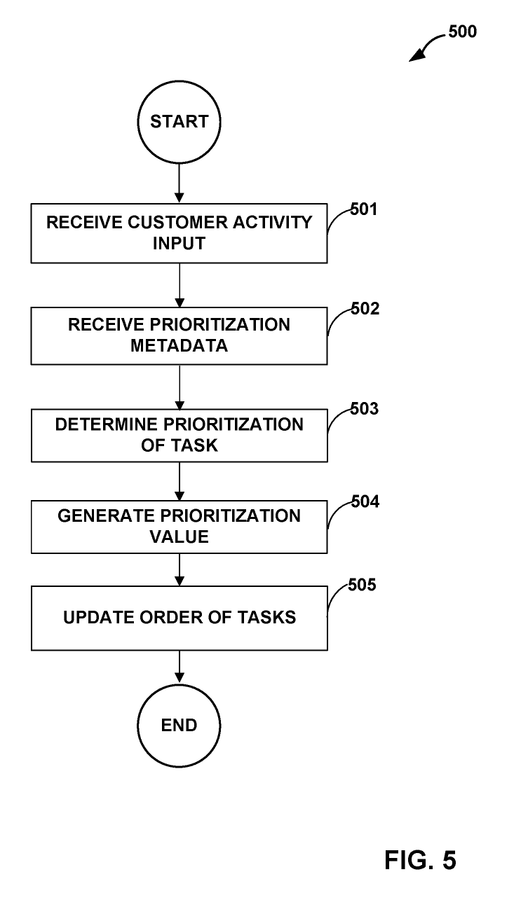

FIG. 5 depicts a flowchart of an example prioritization method 500, in one aspect of the disclosure. Service task prioritization system 22 may receive customer activity input associated with a task from task module 24 (501). Customer activity input may include input from an employee and/or sensors 324 that monitor the status of food or drink. For example, service task prioritization system 22 may receive a status from sensor 324 that a plate or a glass is approaching empty, consistent with a customer getting close to finishing a dish or a drink. Based on the information from sensor 324, task module 24 may update the status of consumption 308 field to indicate that a plate or a glass is approaching empty and that the customer is nearing completion of a dish or a drink. Service task prioritization system 22 may respond to this update to the status of consumption 308 field by providing an indication to the appropriate staff member to ask the customer if the customer would like to order another dish or another drink, for example. In another example, service task prioritization system 22 may respond to this update to the status of consumption 308 field by sending a message directly to the customer, such as via the customer's phone or via a tabletop interface, asking if the customer would like to order another dish or drink.

For another example, service task prioritization system 22 may receive a status from sensor 324 that a plate or a glass (examples of tableware for purposes of status of empty tableware 314 field) is empty. Based on the information from sensor 324, task module 24 may update the status of empty tableware 314 field to indicate that the tableware is empty and may further update the status of clearing 318 field to indicate that the empty plate needs clearing.

Service task prioritization system 22 may also receive prioritization metadata 26 associated with a task (502). Service task prioritization system 22 may determine a prioritization of the task based on customer activity input from task module 24 and prioritization metadata 26 (503). For example, sensor 324 may provide a status update on a status of empty tableware 314 in task module 24 that customers have finished eating. Service task prioritization system 22 may then utilize prioritization metadata 26, such as time limit window 402 that the current policy is to place a higher prioritization on preparing a check because previous customers have indicated their displeasure with the wait time associated with receiving the check. Utilizing the prioritization metadata 26 and status update from task module 24, service task prioritization system 22 may generate a prioritization value 28 to reflect a higher importance for the preparing check 226 task (504). Service task prioritization system 22 may update the order of one or more tasks in task list 12 based on the updated prioritization value 28 (505). In one example, updating the order of tasks in task list 12 may include placing the tasks in an order based on the prioritization value 28.

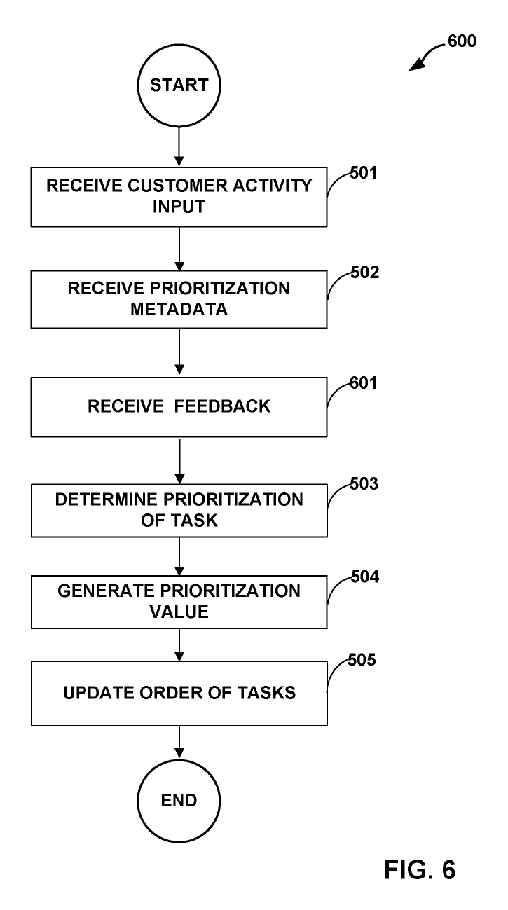

FIG. 6 depicts a flowchart of another example prioritization method 600, in one aspect of the disclosure. Prioritization method 600 of FIG. 6 is analogous to prioritization method 500 of FIG. 5, except as described below. In addition to receiving customer activity input (501) and prioritization metadata (502), service task prioritization system 22 may further receive feedback 326 associated with one or more tasks (601). Feedback may include information from customer surveys, preferences, and/or customer requests. Service task prioritization system 22 may determine a prioritization of the task based on customer feedback information 326, customer activity input and/or prioritization metadata (503). For example, a customer that may regularly visit a particular restaurant may become a “regular” and may have pre-existing preferences recorded, such as for consuming only half of the food and packaging the remainder. In this example, task module 24 may utilize feedback 326 associated with the “regular” and may modify the status of status of consumption 308 field or empty tableware 314 field to monitor half-consumed tableware. Moreover, service task prioritization system 22 may then utilize prioritization metadata 26, such as urgency weighting 404 that the current policy for this “regular” is to place a higher prioritization on preparing a check when the food is half-consumed. Service task prioritization system 22 may generate a prioritization value 28 of a task (504) based on feedback 326 and prioritization metadata 26. In the previous example, service task prioritization system 22 may generate a higher prioritization value 28 for preparing a check 226 for the “regular” when food is half-consumed. Service task prioritization system 22 may update the order of one or more tasks in task list 12 based on prioritization value 28 (505). In another example, determination of priority may include the determination of prioritization of tasks in a singular level (e.g., determining prioritization one task at a time) and/or prioritization of tasks viewed in groups or as a whole. In another example, determination of priority may occur in response to reception of a single customer feedback information 326 or may occur in response to a reception of a plurality of customer feedback information 326.

Thus, in various examples, receiving the one or more customer activity inputs may include receiving information from one or more sensors configured for monitoring a remaining amount of a customer's food or drink. In various examples, updating the one or more service tasks based on the prioritization value may include updating the prioritization value based on the remaining amount of the customer's food or drink, and updating at least one of the service tasks based on the updated prioritization value.

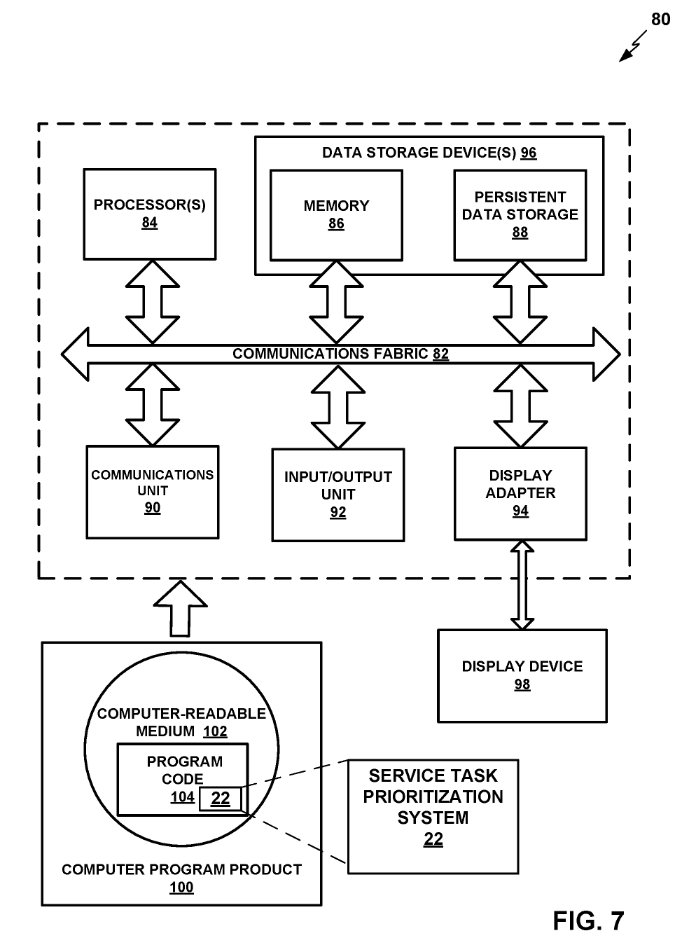

FIG. 7 is a block diagram of a computing device 80 that may be used to implement service task prioritization system 22, in one aspect of this disclosure. Computing device 80 may be a server such as one of web servers or application servers. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind. Other implementations of a computing device 80 may include a computer having capabilities or formats other than or beyond those described herein.

In the illustrative example of FIG. 7, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage mediums. Persistent data storage 88 may store computer-executable instructions or computer-readable program code for an operating system, application files including program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, computer-readable data storage devices. Data storage 96 may include any of various forms of volatile memory that may require being periodically electrically refreshed to maintain data in memory, while those skilled in the art will recognize that this also constitutes an example of a physical computer-readable data storage device. Executable instructions may be stored on a medium when program code is loaded, stored, relayed, buffered, or cached on a physical medium or device, including if only for only a short duration or only in a volatile memory format.

Processor unit 84 can also be suitably programmed to read, load, and execute computer-executable instructions or computer-readable program code for a service task prioritization system 22, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below. In other embodiments, program code 104 need not include all of the program code for service task prioritization system 22, but may include at least program code of one or more of task list 12, task module 24, or prioritization metadata 26.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which includes a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 including computer-executable instructions may be communicated or transferred to computing device 80 from computer-readable medium 102 through a hard-line or wireless communications link to communications unit 90 and/or through a connection to input/output unit 92. Computer-readable medium 102 including program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible mediums, such as communications links or wireless transmissions containing the program code 104. Program code 104 may be more or less temporarily or durably stored on any number of intermediate, physical computer-readable devices and mediums, such as any number of physical buffers, caches, main memory, or data storage components of servers, gateways, network nodes, mobility management entities, or other network assets, en route from its original source medium to computing device 80.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving, with one or more processing devices, one or more customer activity inputs associated with one or more service tasks for performing in a service establishment on behalf of customers of the service establishment;
receiving, with the one or more processing devices, one or more metadata items associated with the one or more service tasks; and
determining, with the one or more processing devices, a prioritization of the one or more service tasks based on the one or more customer activity inputs, wherein determining the prioritization comprises:
generating a prioritization value for the one or more service tasks based at least in part on at least one of the one or more metadata items or the one or more customer activity inputs; and
updating the one or more service tasks based on the prioritization value.

2. The method of claim 1, further comprising:
receiving, with the one or more processing devices, feedback information based at least in part on the customer activity inputs; and
determining, with the one or more processing devices, a prioritization of the one or more service tasks based on the feedback information.

3. The method of claim 1, wherein the feedback information is based at least in part on one of a machine learning algorithm or a genetic algorithm.

4. The method of claim 1, wherein determining the prioritization further comprises adding one or more service tasks based on the prioritization value.

5. The method of claim 1, wherein receiving the customer activity inputs comprises receiving at least one food status information, drink status information, customer status information, table status information, position status information, or device status information.

6. The method of claim 1, wherein receiving the metadata items comprises receiving at least one time limit window, urgency weighting, associated people, or task complexity/time.

7. The method of claim 1, wherein receiving the one or more customer activity inputs comprises receiving information from one or more sensors configured for monitoring a remaining amount of a customer's food or drink,
wherein updating the one or more service tasks based on the prioritization value comprises updating the prioritization value based on the remaining amount of the customer's food or drink, and updating at least one of the service tasks based on the updated prioritization value.

8. A computer system comprising:
one or more processors and one or more computer-readable memories;
program instructions, stored on at least one of the one or more storage mediums for execution by at least one of the one or more processors via at least one of the one or more memories, to receive one or more customer activity inputs associated with one or more service tasks for performing in a service establishment on behalf of customers of the service establishment;
program instructions, stored on at least one of the one or more storage mediums for execution by at least one of the one or more processors via at least one of the one or more memories, to receive one or more prioritization metadata associated with the one or more service tasks; and
program instructions, stored on at least one of the one or more storage mediums for execution by at least one of the one or more processors via at least one of the one or more memories, to determine a prioritization of the one or more service tasks based on the one or more customer activity inputs, wherein the program instructions to determine the prioritization comprises:
program instructions, stored on at least one of the one or more storage mediums for execution by at least one of the one or more processors via at least one of the one or more memories, to generate a prioritization value for the one or more service tasks based at least in part on at least one of the one or more metadata items or the one or more customer activity inputs; and
program instructions, stored on at least one of the one or more storage mediums for execution by at least one of the one or more processors via at least one of the one or more memories, to update the one or more service tasks based on the prioritization value.

9. The computer system of claim 8, further comprising:
program instructions, stored on at least one of the one or more storage mediums for execution by at least one of the one or more processors via at least one of the one or more memories, to receive feedback information based at least in part on the customer activity input; and
program instructions, stored on at least one of the one or more storage mediums for execution by at least one of the one or more processors via at least one of the one or more memories, to determine a prioritization of the one or more service tasks based on the feedback information.

10. The computer system of claim 9, wherein the feedback information is based at least in part on one of a machine learning algorithm or a genetic algorithm.

11. The computer system of claim 8, further comprising program instructions, stored on at least one of the one or more storage mediums for execution by at least one of the one or more processors via at least one of the one or more memories, to add one or more service tasks based on the prioritization value.

12. The computer system of claim 8, wherein the program instructions to receive the one or more customer activity inputs comprise program instructions to receive at least one food status information, drink status information, customer status information, table status information, position status information, or device status information.

13. The computer system of claim 8, wherein the program instructions to receive the metadata items comprise program instructions to receive at least one time limit window, urgency weighting, associated people, or task/complexity information.

14. The computer system of claim 8, wherein the program instructions to receive the one or more customer activity inputs comprise program instructions to receive information from one or more sensors configured for monitoring a remaining amount of a customer's food or drink,
wherein the program instructions to update the one or more service tasks based on the prioritization value comprise program instructions to update the prioritization value based on the remaining amount of the customer's food or drink, and program instructions to update at least one of the service tasks based on the updated prioritization value.

15. A computer program product comprising a computer-readable storage medium having program code embodied therewith, the program code executable by a processor to:
receive one or more customer activity inputs associated with one or more service tasks for performing in a service establishment on behalf of customers of the service establishment;
receive one or more metadata items associated with the one or more service tasks; and
determine a prioritization of the one or more service tasks based on the one or more customer activity inputs, wherein the program code to determine the prioritization comprises program code to:
generate a prioritization value for the one or more service tasks based at least in part on at least one of the one or more metadata items or the one or more customer activity inputs; and
update the one or more service tasks based on the prioritization value.

16. The computer program of claim 15, wherein the program code is further executable by the processor to receive feedback information based at least in part on the customer activity inputs; and
to determine a prioritization of the one or more service tasks based on the feedback information.

17. The computer program of claim 16, wherein the feedback information is based at least in part on one of a machine learning algorithm or a genetic algorithm.

18. The computer program of claim 15, wherein the program code is further executable by the processor to add one or more service tasks based on the prioritization value.

19. The computer program of claim 15, wherein the program code to receive the customer activity inputs further comprises at least one food status information, drink status information, customer status information, table status information, position status information, or device status information.

20. The computer program of claim 15, wherein the program code to receive the metadata items further comprises at least one time limit window, urgency weighting, associated people, or task/complexity information.
